(19) United States
(12) Patent Application Publication
(10) Pub. No.: US 2014/0320511 A1
(43) Pub. Date: Oct. 30, 2014

(54) DISPLAY CONTROLLER INTERRUPT REGISTER

(71) Applicants: Xianchao James Xu, Beijing (CN); Lili Sophia Gong, Beijing (CN)

(72) Inventors: Xianchao James Xu, Beijing (CN); Lili Sophia Gong, Beijing (CN)

(21) Appl. No.: 13/977,433

(22) PCT Filed: Dec. 26, 2011
(86) PCT No.: PCT/CN2011/084658

§ 371 Date: Sep. 17, 2013

(51) Int. Cl. G09G 5/393; G09G 5/395

(52) U.S. Cl. CPC G09G 5/393; G09G 5/395; G09G 2360/127
USPC 345/531

(57) ABSTRACT

Systems, apparatus, articles, and methods are described including operations to set an interrupt range in an interrupt register associated with a display controller. A determination may be made regarding whether a front buffer portion of a frame buffer is within the interrupt range. An interrupt may be communicated based at least in part on the determination that the front buffer portion of the frame buffer is within the interrupt range.

### BACKGROUND

Currently, some users may still be suffering from the tearing of a screen when they watch a video or play games. In general, such tearing may he happening when a display controller scans the frame buffer when the frame buffer is being updated at the same time. These conflicts of the read and write on the frame buffer, will produce the tearing. When the users are playing the games or watching the video, the screen is updated frequently; it is highly possible that the display controller will conflict with the update of frame buffer and introduce the tearing.

For the tearing issue produced by the conflict of the display controller scanning and the write to the frame buffer, one solution is to use flip method. In such a flip method, new screen content may be written to a back buffer first. Then, when the display controller finishes the scanning of active area and after a vertical blanking interval (VBLANK) interrupt is received, the system may flip the back buffer with front buffer.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example an graphics processing system;

FIG. 2 is a flow chart illustrating an example interrupt process;

FIG. 3 is an illustrative diagram of an example graphics processing system in operation;

FIG. 4 is an illustrative diagram of an example system; and

FIG. 5 is an illustrative diagram of an example system, all arranged in accordance with at least some implementations of the present disclosure,

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc,. may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism fur storing or transmitting information in a form readable by a machine (e.g., computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

As will be described in greater detail below, some example implementation may include operations to set an interrupt range in an interrupt register associated with a display controller. A determination may be made regarding whether a front buffer portion of a frame buffer is within the interrupt range. An interrupt may be communicated based at least in part on the determination that the from buffer portion of the frame buffer is within the interrupt range,

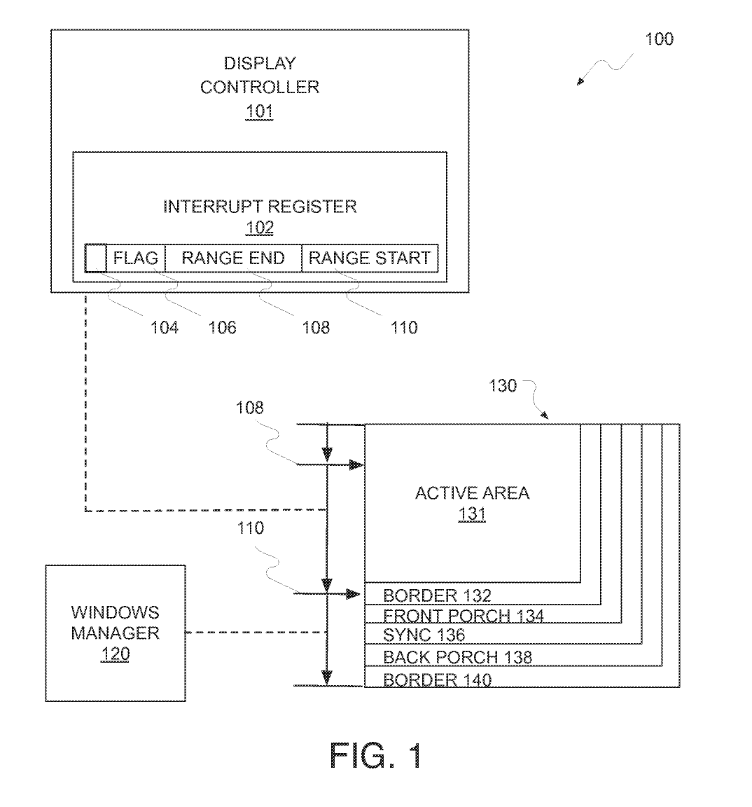

FIG. 1 is an illustrative diagram of a graphics processing system 100, arranged in accordance with at least some implementations of the present disclosure. In the illustrated implementation, graphics processing system 100 may include a display controller 101, a windows manager 120, and/or a frame buffer 130, in some examples, graphics processing system 100 may include additional items that have not been shown in FIG. 1 for the sake of clarity. For example, graphics processing system 100 may include a processor, a radio frequency-type (RF) transceiver, and/or an antenna. Further, graphics processing system 100 may include additional items such as a speaker, a display, an accelerometer, memory, a router, network interface logic, etc. that have not been shown in FIG. 1 for the sake of clarity.

In operation, windows manager 120 may be configured to transfer image data to frame buffer 130. Similarly, display controller 101 may be configured to scan image data from frame buffer 130.

In the illustrated implementation, display controller 101 may include an interrupt register 102. In some examples, interrupt register 102 may include a reserved bit 104 potion, a flag 106 portion, a range end 108 portion, and/or a range start 110 portion. For example, interrupt register 102 may he a thirty-two bit register where reserved bit 104 may be a one bit potion, flag 106 may be a one bit portion, range end 108 may be a fifteen hit portion, and range start 110 may be a fifteen bit portion.

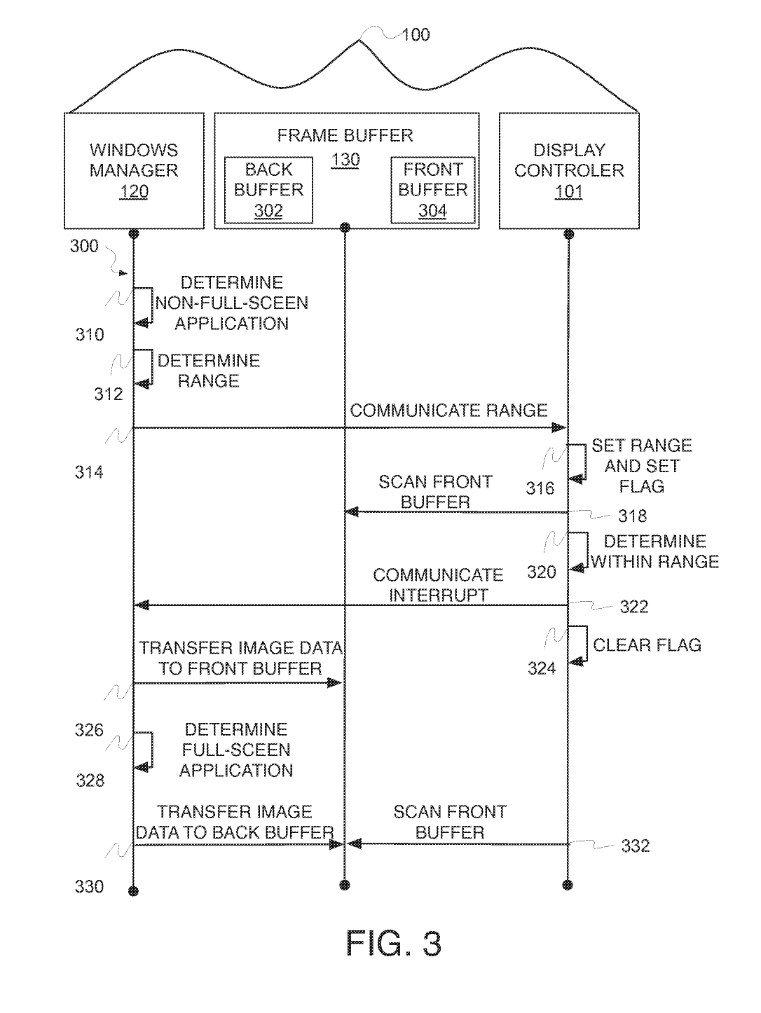

In operation, flag 106 may provide indicia of whether to enable or disable an interrupt operation. Additionally, range start 110 and/or range end 108 may specify an interrupt range during which time an interrupt communication may be communicated. For example, interrupt register 102 may be configured to inform display controller 101 to communicate an interrupt when a front register portion (see, e.g. FIG. 3) of frame butler 130 is within the interrupt range. For example, the interrupt range may be specified by range start 110 and/or range end 108. In such an example, range start 110 and/or range end 108 may be configured to inform display controller 101 to communicate an interrupt when frame buffer 130 is within an interrupt range.

In the illustrated implementation, frame buffer 130 may include an above area 131 portion, a border 132 portion, a front porch 134 portion, a synch 136 portion, a back porch 138 portion, and/or a border 140 portion.

In examples where an active application being displayed is a full-screen application, display controller 101 may scan frame buffer 130 line by line. When display controller 101 finishes the scanning of the active area 131, display controller 101 may produce a VBLANK interrupt. For example, such a VBLANK interrupt may be produced after front porch 134. After the VBLANK interrupt, there may be an interval before display controller 101 will scan active area 131 again. Windows manager 120 may first transfer the latest screen image data to a back buffer portion of frame buffer 130 (see, e.g., back buffer 302 of FIG. 3). When the VBLANK interrupt is triggered, windows manager 120 may do a flip operation and swap pointers to the back buffer and a front buffer (see, e.g., front buffer 304 of FIG. 3) immediately. Because the flip operation is very quick, it may avoid the conflict and subsequent tearing.

While such a flip operation by windows manager 120 may be effective when dealing with a full-screen application, such a flip operation by windows manager 120 may have drawbacks when dealing with a non-full-screen application. As used herein, the term “non-full-screen application” may refer to applications that do not occupy the entire screen, such as, windows-based applications, for example. In some examples, such a flip operation by windows manager 120 may non-full-screen applications may need another copy operation to update new content from a render buffer to the back buffer, which may introduce performance loss. So the windows-based apps have to fall back to do a bit-block image transfer (BLIT).

Further, such a BLIT operation after the VBLANK interrupt may not avoid the tearing in current graphics systems. Many embedded graphics processing units (GPUs) (e.g., PowerVR or the like) may implement a micro kernel to schedule the commands and/or tasks inside its hardware core. By this mechanism, the software may send many commands to the GPU, and the GPU may complete all the tasks without the software or central processing unit's (CPU) involvement. This method could reduce the power consumption and also improve the whole system performance, but it may introduce a delay between the software sending the command and the hardware processing the command. So even if a PowerVR-type GPU could do a hardware BLIT very fast, due to the delay, there may still be many conflicts between the hardware BLIT and display controller scanning, which may typically result in tearing.

Lastly, such a flip operation by windows manager 120 may introduce a performance loss, because each update to frame buffer 130 may wait for the VBLANK interrupt, where the interval may depend on the screen refresh rate. For example, at the 60 HZ refresh rate, windows manager 120 may to wait for about sixteen milliseconds to get a VBLANK interrupt before windows manager 120 can flip the frame buffer.

Accordingly, in some implementations associated with non-full-screen applications, display controller 101 may utilize minx start 110 and/or range end 108 stored in interrupt register 102 to specify an interrupt range during which time an interrupt communication may be communicated. For example, interrupt register 102 may be configured to inform display controller 101 to communicate an interrupt when frame buffer 130 is within the interrupt range. In such an example, interrupt register 102 may allow display controller 101 to support a more flexible interrupt configuration. An interrupting window range may be configured for display controller 101 to generate the desired interrupt. For example, a delay associated with the BLIT operation and/or the flip operation, a speed associated with the BLIT operation and/or the flip operation, and/or the like may be considered when calculating the suitable interrupting window. For example, such a flexible interrupt configuration may permit display controller 101 to produce the interrupt at a configurable range of the screen (e.g. not necessarily petforming the interrupt only at VBLANK). Such a flexible interrupt configuration for non-full-screen applications may avoid the tearing and also may provide improved performance.

In operation, interrupt register 102 may be exposed to windows manager 120, where windows manager 120 may configure display controller 101 by setting interrupt register 102 to get the interrupt from display controller 101 in a desired timing, range. When scanning by display controller 101 reaches range start 110 (or it is already in the range specified in register 102), display controller 101 may produce the interrupt immediately. When windows manager 120 needs to BLIT to frame buffer 130, windows manager 120 may calculate the suitable interrupt range for the schedule of the BLIT/FLIP, by considering the delay to kick off the BLIT and/or flip operation, the BLIT and/or flip operation speed, and the scanning speed of display controller 101. When the suitable interrupt range is decided, windows manager 120 may set the interrupt range into interrupt register 102 and enable the interrupt via flag 106, in such a process, windows manager 120 may get a suitably timed interrupt for different situations and non-full-screen applications may avoid tearing. Additionally, such a flexible interrupt configuration may, in some eases, give windows manager 120 an earlier interrupt from display controller 101 as compared with waiting for the VBLANK interrupt.

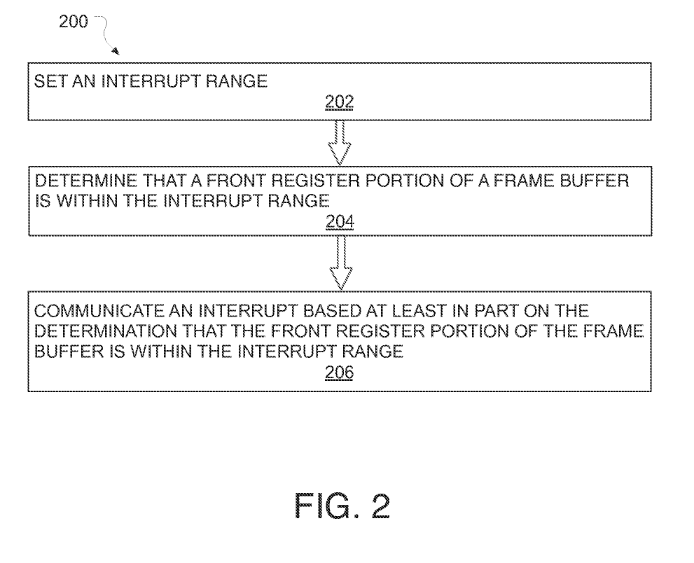

FIG. 2 is a flow chart illustrating an example interrupt process 200, arranged in accordance with at least some implementations of the present disclosure. In the illustrated implementation, process 200 may include one or more operations, functions or actions as illustrated by one or more of blocks 202, 204, and or 206. By way of non-limiting example, process 200 will he described herein with reference to example graphics processing system 100 of FIG. 1.

Process 200 may begin at block 202, “SET AN INTERRUPT RANGE”, where an interrupt range may be set. For example, the interrupt range may be set via a display controller. In some examples the interrupt range may be set in an interrupt register associated with the display controller.

Processing may continue from operation 202 to operation 204, “DETERMINE THAT A FRONT BUFFER PORTION OF A FRAME BUFFER IS WITHIN THE INTERRUPT RANGE”, where a determination may be made that a front buffer portion of a frame buffer is within the interrupt range. For example, the display controller may determine that the front buffer portion of the frame butler is within the interrupt range. Processing may continue from operation 204 to operation 206, “COMMUNICATE AN INTERRUPT BASED AT LEAST IN PART ON THE DETERMINATION THAT THE FRONT BUFFER PORTION OF THE FRAME BUFFER IS WITHIN THE INTERRUPT RANGE”, where an interrupt may be communicated. For example, the interrupt may be communicated, via the display controller, to a windows manager. In some examples, the interrupt may be communicated based at least in part on the determination that the front buffer portion of the frame buffer is within the interrupt range.

Some additional and/or alternative details related to process 200 may be illustrated in one or more examples of implementations discussed in greater detail below with regard to FIG. 3.

FIG. 3 is an illustrative diagram of example graphics processing system 100 and interrupt process 300 in operation, arranged in accordance with at least some implementations of the present disclosure. In the illustrated implementation, process 300 may include one or more operations, Inactions or actions as illustrated by one or more of actions 310, 312, 314, 316, 318, 320, 322, 324, 326, 328, 330 and/or 332. By way of non-limiting example, process 300 will he described herein with reference to example graphics processing system 100 of FIG. 1.

In the illustrated implementation, graphics processing system 100 may include display controller 101, windows manager 120, and/or frame buffer 130. Additionally, frame buffer 130 may include a back buffer 320 and/or a front buffer 304. As illustrated, display controller 101, windows manager 120, and/or frame buffer 130 may be capable of communication with one another. Although graphics processing system 100, as shown in FIG. 3, may include one particular set of blocks or actions associated with particular modules, these blocks or actions may he associated with different modules than the) particular module illustrated here.

Process 300 may begin at block 310, “DETERMINE NON-FULL-SCEEN APPLICATION”, where a determination may be made whether an active application is a non-full-screen application. For example, windows manager 120 may make a determination whether an active application is a non-full-screen application or a full-screen application. In cases where the active application is determined to be a non-full-screen application, processing may continue to operation 312.

Processing may continue from operation 310 to operation 312, “DETERMINE RANGE”, where the interrupt range may be determined. For example, windows manager 120 may determine the interrupt range. In some examples, the interrupt range may be determined based at least in pan on a delay associated with an image transfer operation of windows manager 120, a speed associated with the image transfer operation of windows manager 120, and/or on a scanning speed of display controller 101.

Processing may continue from operation 312 to operation 314, “COMMUNICATE RANGE”, where the interrupt range may be communicated. For example, the interrupt range may he communicated, via windows manager 120, to display controller 101. In some implementations, a setting by display controller 101 of the interrupt range in interrupt register 102 (see, e.g., FIG. 1) may be based at least in part on the determined interrupt range.

Processing may continue from operation 314 to operation 316. “SET RANGE AND SET FLAG”, where an interrupt range may be set. For example, the interrupt range may be set via display controller 101. In some examples, the interrupt range may be set in an interrupt register associated with display controller 101.

Additionally, in some examples, operation 316 may include setting of a flag (e,g., flag 10$ of FIG. 1. For example, the flag may be set via display controller 101. In some examples the flag may he set in the interrupt register associated with display controller 101. As discussed above, the set flag may provide indicia to enable the interrupt operation,

Processing may continue from operation 316 to operation 318, “SCAN FRONT BUFFER”, where front buffer 304 portion of frame buffer 130 may be scanned. For example, front buffer 304 may he scanned via display controller 101. In some implementations, front buffer 304 may he scanned via display controller 101 when front buffer 304 is not within the interrupt range and when the active application is a non-fall-screen application.

Processing may continue from operation 318 to operation 320, “DETERMINE WITHIN RANGE”, where a determination may be made that front buffer portion 304 of frame buffer 130 is within the interrupt range. For example, display controller 101 may determine that front buffer 304 portion of frame buffer 130 is within the interrupt range.

Processing may continue from operation 320 to operation 322, “COMMUNICATE INTERRUPT”, where an interrupt may be communicated. For example, the interrupt may be communicated, via display controller 101, to windows manager 120. In some examples, the interrupt may be communicated based at least in part on the determination that front buffer 304 portion of frame buffer 130 is within the interrupt range.

Processing may continue from operation 322 to operation 324, “CLEAR FLAG”, where the flag may be cleared. For example, the flag may be cleared in the interrupt register (e.g., interrupt register 102 of FIG. 1), via display controller 101, to indicate that. As discussed above, the cleared flag may provide indicia to disable the interrupt operation.

Processing may also continue from operation 324 to operation 326, “TRANSFER IMAGE DATA TO FRONT BUFFER”, where image data associated with the active application may be transferred to front buffer 304. For example, image data may be transferred to front buffer 304 via windows manager 120. In some implementations, image data may be transferred to front butler 304 when front buffer 304 is within the interrupt range and when the active application is a non-full-screen application. Such a transfer may be triggered and/or timed based at least in part on the communicated interrupt,

In addition to operations 310-326, process 300 may include operations 328-332, which may not depend on the timing of operations 310-326. Process 300 may include operation 328, “DETERMINE FULL-SCEEN APPLICATION”, where a determination may be made whether an active application is a full-screen application. For example, windows manager 120 may make a determination whether an active application is a non-full-screen application or a full-screen application. In cases where the active application is determined to be a fall-screen application, processing may continue to operation 330.

Processing may continue from operation 328 to operation 330, “TRANSFER IMAGE DATA TO BACK BUFFER”, where image data may be transferred to back buffer 302 portion of frame buffer 130. For example, image data may be transferred to back buffer 302 via windows manager 120. In some implementations, image data may be transferred to back buffer 302 based at least in part on the determination that the active application is a full-screen application.

Processing may continue from operation 330 to operation 332, “SCAN FRONT BUFFER”, where front buffer 304 portion of frame buffer 130 may be scanned. For example, front buffer 304 may be scanned via display controller 101. In some implementations, front buffer 304 may be scanned, when the active application is a full-screen application, at the same time as the transfer of image data associated with the active application to back buffer 302. In some examples, operation 330 and 332 may be performed at the same time, different times, or similar times.

While full-screen applications have been, described above as being processed via operations 328-332, in some implementations, process 300 and/or process 200 may process full-screen applications in the same or similar manner as non-full-sceen applications. For example, in some implementations, full-screen applications may be processed via operation 312-326 in the same or similar manner as non-full-screen applications. In such an implementation, process 300 may BLIT contents from back buffer 302 to front buffer 304.

In operation, process 300 and/or process 200 may expose interrupt register 102 to windows manager 120, where windows manager 120 may configure display controller 101 by setting the interrupt register to get the interrupt from display controller 101 in a desired timing range. When scanning by display controller 101 reaches the range start (or it is already in the range specified in the interrupt register), display controller 101 may produce the interrupt immediately. When windows manager 120 needs to transfer image data to frame buffer 130, windows manager 120 may calculate the suitable interrupt range for the schedule of the image data transfer. When the suitable interrupt range is decided, windows manager 120 may set the interrupt range into the interrupt register and enable the interrupt via the flag. In such a process, windows manager 120 may get a suitably time interrupt for different situations and non-full-screen applications may avoid tearing. Additionally, such a flexible interrupt configuration may in some cases, give windows manager 120 an earlier interrupt from display controller 101 as compared with waiting for the VBLANK interrupt.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

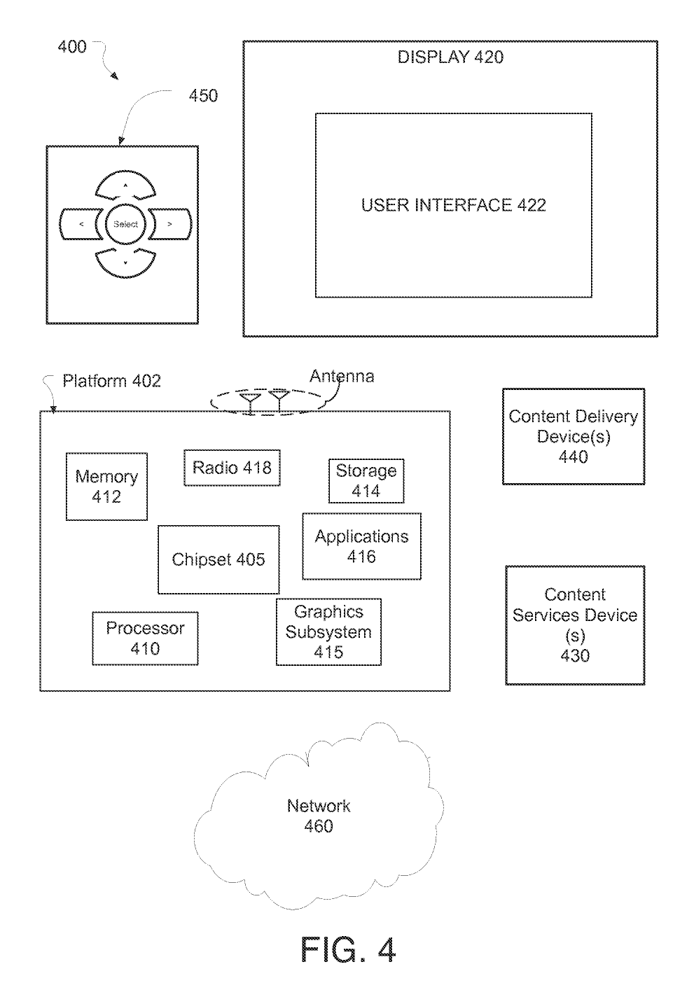

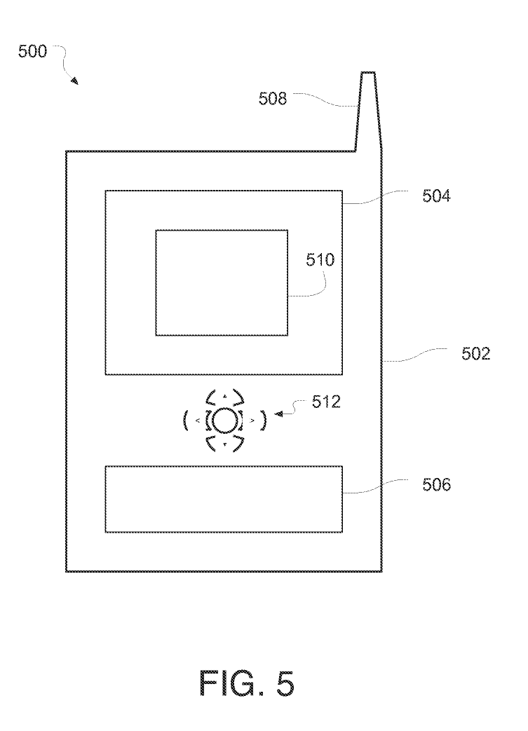

In addition, any one or more of the blocks of FIGS. 2 and 3 may he undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the block's shown in FIGS. 4 and 5 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

FIG. 4 illustrates an example system 400 in accordance with the present disclosure. In various implementations, system 400 may be a media system although system 400 is not limited to this context. For example, system 400 may be incorporated into a personal computer (PC), laptop computer, ultra-laptop computer, tablet, touch pad, portable computer, handheld computer, palmtop computer, personal digital assistant (FDA), cellular telephone, combination cellular telephone/PDA, television, smart device (e.g., smart phone, smart tablet or smart television), mobile internet device (MI)), messaging device, data communication device, and so forth.

In various implementations, system 400 includes a platform 402 coupled to a display 420. Platform 402 may receive content from a content device such as content services device(s) 430 or content delivery device(s) 440 or other similar content sources. A navigation controller 450 including one or more navigation features may be used to interact with, for example, platform 402 and/or display 420. Each of these components is described in greater detail below.

In various implementations, platform 402 may include any combination of a chipset 405, processor 410, memory 412, storage 414, graphics subsystem 415, applications 416 and/or radio 418. Chipset 405 may provide intercommunication among processor 410, memory 412, storage 414, graphics subsystem 415, applications 416 and/or radio 418. For example, chipset 405 may include a storage adapter (not depicted) capable of providing intercommunication with storage 414.

Processor 410 may be implemented as a Complex Instruction Set Computer (CISC) or Reduced. Instruction Set Computer (RISC) processors; x86 instruction set compatible processors, multi-core, or any other microprocessor or central processing unit (CPU). In various implementations, processor 410 may be dual-core processor(s), dual-core mobile processor(s), and so forth.

Memory 412 may he implemented as a volatile memory device such as, but not limited to a Random Access Memory (RAM), Dynamic Random Access Memory (DRAM), or Static RAM (SRAM).

Storage 414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 414 may include technology to increase the storage performance enhanced protection for valuable digital media when multiple hard drives are included, for example.

Graphics subsystem 415 may perform processing of images such as still or video for display. Graphics subsystem 415 may b a graphics processing unit (GPU) or a visual processing unit (VPLI), for example. An analog or digital interface may be used to communicatively couple graphics subsystem 415 and display 420. For example, the interface may be any of a High-Definition Multimedia Interface. DisplayPort, wireless end/or wireless HD compliant techniques. Graphics subsystem 415 may be integrated into processor 410 or chipset 405. In some implementations, graphics subsystem 415 may be a stand-alone card communicatively coupled to chipset 405.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 418 may include one or more radios capable of transmitting and receiving signals using various suitable wireless communications techniques. Such techniques may involve communications across one or more wireless networks. Example wireless networks include (but are not limited to) wireless local area networks (WLANS), wireless personal area networks (WPANs), wireless metropolitan area network (WMANs), cellular networks, and satellite networks. In communicating across such networks, radio 418 may operate in accordance with one or more applicable standards in any version,

In various implementations, display 420 may include any television typo monitor or display. Display 420 may include, for example, a computer display screen, touch screen display, video monitor, television-like device, and/or a television, Display 420 may be digital and/or analog. In various implementations, display 420 may be a holographic display. Also, display 420 may be a transparent surface that may receive a visual projection. Such projections may convey various forms of information, images, and/or objects. For example, such projections may be a visual overlay for a mobile augmented reality (MAR) application. Under the control of one or more software applications 416, platform 402 may display user interface 422 on display 420.

In various implementations, content services device(s) 430 may be hosted by any national, international and/or independent service and thus accessible to platform 402 via the Internet, for example. Content services device(s) 430 may be coupled to platform 402 and/or to display 420. Platform 402 and/or content services device(s) 430 may be coupled to a network 460 to communicate (e.g., send and/or receive) media information to and from network 460. Content delivery device(s) 440 also may be coupled to platform 402 and/or to display 420.

In various implementations, content services device(s) 430 may include a cable television box, personal computer, network, telephone, Internet enabled devices or appliance capable of delivering digital information and/or content, and any other similar device capable of unidirectionally or bidirectionally communicating content between content providers and platform 402 and/display 420, via network 460 or directly. It will be appreciated that the content may be communicated unidirectionally anchor bidirectionally to and from any one of the components in system 400 and a content provider via network 460. Examples of content may include any media information including, for example, video, music, medical and gaining information, and so forth.

Content services device(s) 430 may receive content such as cable television programming including media information, digital information, and/or other content. Examples of content providers may include any cable or satellite television or radio or/Internet content providers. The provided examples are not meant to limit implementations in accordance with the present disclosure in any way.

In various implementations, platform 402 may receive control signals from navigation controller 450 having one or more navigation features. The navigation features of controller 450 may be used to interact with user interface 422, for example. In embodiments, navigation controller 450 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 450 may be replicated on a display (e.g., display 420) by movements of a pointer, cursor, focus ring. Or other visual indicators displayed on the display. For example, under the control of software applications 416, the navigation features located on navigation controller 450 may be mapped to virtual navigation features displayed on user interface 422, for example. In embodiments, controller 450 may not be a separate component but may be integrated into platform 402 and/or display 420. The present disclosure, however, is not limited to the elements or in the context shown or described herein.

In various implementations, drivers (not shown) may include technology to enable users to instantly nun on and off platform 402 like, a television with the touch of a button after initial boot-up, when enabled, for example. Program logic may allow platform 402 to stream content to media adaptors or other content services device(s) 430 or content delivery device(s) 440 even when the platform is turned “off,” in addition, chipset 405 may include hardware and/or software support for (5.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 400 may be integrated. For example, platform 402 and content services device(s) 430 may be integrated, or platform 402 and content delivery device(s) 440 may be integrated, or platform 402, content services device(s) 430, and content delivery device(s) 440 may he integrated, for example. In various embodiments, platfont 402 and display 420 may be an integrated unit. Display 420 and content service device(s) 430 may be integrated, or display 420 and content delivery device(s) 440 may be integrated, for example. These examples are not meant to limit the present disclosure.

In various embodiments, system 400 may be implemented as a wireless system, a wired system, or a combination of both. When implemented as a wireless system, system 400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

As described above, system 400 may he embodied in varying physical styles or form factors. FIG. 5 illustrates implementations of a small form factor device 500 in which system 400 may be embodied. In embodiments, for example, device 500 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e,g, smart phone, smart tablet or smart television), mobile internet device (MID), messaging device, data communication device, and so forth.

Examples of a mobile computing device also may include computers that are arranged to he worn by a person, such as a wrist computer, finger computer, ring computer, eyeglass computer, belt-clip computer, arm-band computer, shoe computers, clothing computers, and other wearable computers. In various embodiments, for example, a mobile computing device may he implemented as a smart phone capable of executing computer applications, as well as voice communications and/or data communications. Although sonic embodiments may he described with a mobile computing device implemented as a smart phone by way of example, it may be appreciated that other embodiments may be implemented using other wireless mobile computing devices as well. The embodiments are not limited in this context.

As shown in FIG. 5, device 500 may include a housing 502, a display 504, an input/output (I/O) device 506, and an antenna 508. Device 500 also may include navigation features 512. Display 504 may include any suitable display unit for displaying information appropriate for a mobile computing device I/O device 50$ may include any suitable I/O device for entering information into a mobile computing device. Examples for I/O device 506 may include an alphanumeric keyboard, a numeric keypad, a touch pad, input keys, buttons, switches, rocker switches, microphones, speakers, voice recognition device and software, and so forth. Information also may be entered into device 500 by way of microphone (not shown). Such information may he digitized by a voice recognition device (not shown). The embodiments are not limited in this context.

Various embodiments may be implemented using hardware elements, software elements, or a combination of both. Examples of hardware elements may include processors, microprocessors, circuits, circuit elements e,g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth, Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-27. (canceled)

28. A computer-implemented method, comprising:
setting, via a display controller, an interrupt range in an interrupt register associated with the display controller;
determining, via the display controller, that a front buffer portion of a frame buffer is within the interrupt range; and
communicating, via the display controller, an interrupt to a windows manager based at least in part on the determination that the front buffer portion of the frame buffer is within the interrupt range.

29. The method of claim 28 further comprising:
determining, via the windows manager, that an active application is a non-full-screen application;
determining, via the windows manager, the interrupt range; and
communicating, via the windows manager, the interrupt range to the display controller, wherein, the setting by the display controller of the interrupt range is based at least in part on the determined interrupt range.

30. The method of claim 28, further comprising:
determining, via the windows manager, that an active application is a non-full-screen application;
determining, via the windows manager, the interrupt range, wherein the interrupt ranges is based at least in part on a delay associated with an image transfer operation of the windows manager, a speed associated with the image transfer operation of the windows manager, and/or on a scanning speed of the display controller; and communicating, via the windows manager, the interrupt range to the display controller, wherein, the setting by the display controller of the interrupt range is based at least in part on the determined interrupt range.

31. The method of claim 28, further comprising: scanning, via the display controller, the front buffer portion of the frame buffer when the front buffer portion of the frame buffer is not within the interrupt range and when an active application is a non-full-screen application.

32. The method of claim 28, further comprising: transferring, via the windows manager, image data associated with the active application to a front buffer portion of the frame buffer when the front buffer portion of the frame buffer is within the interrupt range and when an active application is a non-full-screen application based at least in part on the communicated interrupt.

33. The method of claim 28, further comprising:
determining, via the windows manager, whether an active application is a non-full-screen application or a full-screen application;
transferring, via the windows manager, image data associated with the active application to a back buffer portion of the frame buffer based at least in part on the determination that the active application is a full-screen application; and
scanning, via the display controller, the front buffer portion of the frame buffer when an active application is a full-screen application at the same time as the transfer of image data associated with the active application to the back buffer portion of the frame buffer.

34. The method of claim 28, further comprising:
determining, via the windows manager, whether an active application is a non-full-screen application or a full-screen application;
scanning, via the display controller, the front buffer portion of the frame buffer when the front buffer portion of the frame buffer is not within the interrupt range and when an active application is a non-full-screen application;
transferring, via the windows manager, image data associated with the active application to a front buffer portion of the frame buffer when the front buffer portion of the frame buffer is within the interrupt range and when the active application is a non-full-screen application based at least in part on the communicated interrupt;
transferring, via the windows manager, image data associated with the active application to a back buffer portion of the frame buffer based at least in part on the determination that the active application is a full-screen application; and
scanning, via the display controller, the front buffer portion of the frame buffer when the active application is a full-screen application at the same time as the transfer of image data associated with the active application to the back buffer portion of the frame buffer.

35. The method of claim 28, further comprising:
determining, via the windows manager, whether an active application is a non-full-screen application or a full-screen application;
determining, via the windows manager, the interrupt range, wherein the interrupt ranges is based at least in part on a delay associated with an image transfer operation of the windows manager, a speed associated with the image transfer operation of the windows manager, and/or on a scanning speed of the display controller;
communicating, via the windows manager, the interrupt range to the display controller, wherein, the setting by the display controller of the interrupt range is based at least in part on the determined interrupt range;
scanning, via the display controller, the front buffer portion of the frame buffer when the front buffer portion of the frame buffer is not within the interrupt range and when the active application is a non-full-screen application;
transferring, via the windows manager, image data associated with the active application to a front buffer portion of the frame buffer when the front buffer portion of the frame buffer is within the interrupt range and when the active application is a non-full-screen application based at least in part on the communicated interrupt;
transferring, via the windows manager, image data associated with the active application to a back buffer portion of the frame buffer based at least in part on the determination that the active application is a full-screen application; and
scanning, via the display controller, the front buffer portion of the frame buffer when the active application is a full-screen application at the same time as the transfer of image data associated with the active application to the back buffer portion of the frame buffer.

36. An article comprising a computer program product having stored therein instructions that, if executed, result in:
setting, via a display controller, an interrupt range in an interrupt register associated with the display controller;
determining, via the display controller, that a front buffer portion of a frame buffer is within the interrupt range; and
communicating, via the display controller, an interrupt to a windows manager based at least in part on the determination that the front buffer portion of the frame buffer is within the interrupt range.

37. The article of claim 36, wherein the instructions, if executed, further result in:
determining, via the windows manager, whether an active application is a non-full-screen application or a full-screen application;
scanning, via the display controller, the front buffer portion of the frame buffer when the front buffer portion of the frame buffer is not within the interrupt range and when an active application is a non-full-screen application;
transferring, via the windows manager, image data associated with the active application to a front buffer portion of the frame buffer when the front buffer portion of the frame buffer is within the interrupt range and when the active application is a non-full-screen application based at least in part on the communicated interrupt;
transferring, via the windows manager, image data associated with the active application to a back buffer portion of the frame buffer based at least in part on the determination that the active application is a full-screen application; and
scanning, via the display controller, the front buffer portion of the frame buffer when the active application is a full-screen application at the same time as the transfer of image data associated with the active application to the back buffer portion of the frame buffer.

38. An apparatus, comprising:
a display controller comprising an interrupt register, wherein the display controller is configured to:
set an interrupt range in the interrupt register associated with the display controller;
determine that a front buffer portion of a frame buffer is within the interrupt range; and
communicate an interrupt to a windows manager based at least in part on the determination that the front buffer portion of the frame buffer is within the interrupt range.

39. The apparatus of claim 38, wherein the display controller is further configured to: set a flag in the interrupt register associated with the display controller to provide an indicia of whether to enable or disable communication of the interrupt.

40. The apparatus of claim 38, wherein the display controller is further configured to: scan the front buffer portion of the frame buffer when the front buffer portion of the frame buffer is not within the interrupt range and when an active application is a non-full-screen application.

41. The apparatus of claim 38, wherein the display controller is further configured to:
scan the front buffer portion of the frame buffer when the front buffer portion of the frame buffer is not within the interrupt range and when an active application is a non-full-screen application;
scan the front buffer portion of the frame buffer when the active application is a full-screen application at the same time as a transfer of image data associated with the active application to the back buffer portion of the frame buffer.

42. A system comprising:
a frame buffer;
a windows manager module, wherein the windows manager module is communicatively coupled to the frame buffer, and wherein the windows manager module is configured to transfer image data to the frame buffer; and
a display controller comprising an interrupt register, wherein the display controller is communicatively coupled to the frame buffer and the windows manager module, and wherein the display controller is configured to:
set an interrupt range in the interrupt register associated with the display controller;
determine that a front buffer portion of the frame buffer is within the interrupt range; and
communicate an interrupt to the windows manager module based at least in part on the determination that the front buffer portion of the frame buffer is within the interrupt range.

43. The system of claim 42, wherein the display controller is further configured to: set a flag in the interrupt register associated with the display controller to provide an indicia of whether to enable or disable communication of the interrupt.

44. The system of claim 42, wherein the windows manager module is further configured to:
determine that an active application is a non-full-screen application;
determine the interrupt range; and
communicate the interrupt range to the display controller, wherein, the setting by the display controller of the interrupt range is based at least in part on the determined interrupt range.

45. The system of claim 42, wherein the windows manager module is further configured to:
determine that an active application is a non-full-screen application;
determine the interrupt range, wherein the interrupt ranges is based at least in part on a delay associated with an image transfer operation of the windows manager module, a speed associated with the image transfer operation of the windows manager module, and/or on a scanning speed of the display controller; and
communicate the interrupt range to the display controller, wherein, the setting by the display controller of the interrupt range is based at least in part on the determined interrupt range.

46. The system of claim 42, wherein the display controller is further configured to: scan the front buffer portion of the frame buffer when the front buffer portion of the frame buffer is not within the interrupt range and when an active application is a non-full-screen application.

47. The system of claim 42, wherein the windows manager module is further configured to:
transfer image data associated with the active application to a front buffer portion of the frame buffer when the front buffer portion of the frame buffer is within the interrupt range and when an active application is a non-full-screen application based at least in part on the communicated interrupt.

48. The system of claim 42, wherein the windows manager module is further configured to:
determine whether an active application is a non-full-screen application or a full-screen application;
transfer image data associated with the active application to a back buffer portion of the frame buffer based at least in part on the determination that the active application is a full-screen application; and
scan, via the display controller, the front buffer portion of the frame buffer when an active application is a full-screen application at the same time as the transfer of image data associated with the active application to the back buffer portion of the frame buffer.

49. The system of claim 42, wherein the windows manager module is further configured to:
determine whether an active application is a non-full-screen application or a full-screen application;
scan, via the display controller, the front buffer portion of the frame buffer when the front buffer portion of the frame buffer is not within the interrupt range and when an active application is a non-full-screen application;
transfer image data associated with the active application to a front buffer portion of the frame buffer when the front buffer portion of the frame buffer is within the interrupt range and when the active application is a non-full-screen application based at least in part on the communicated interrupt;
transfer image data associated with the active application to a back buffer portion of the frame buffer based at least in part on the determination that the active application is a full-screen application; and
scan, via the display controller, the front buffer portion of the frame buffer when the active application is a full-screen application at the same time as the transfer of image data associated with the active application to the back buffer portion of the frame buffer.
